(19) United States
(12) Patent Application Publication
(10) Pub. No.: US 2026/0156671 A1
(43) Pub. Date: Jun. 4, 2026

(54) RELAY TERMINAL, BASE STATION, COMMUNICATION METHOD, AND STORAGE MEDIUM

(71) Applicant: CANON KABUSHIKI KAISHA, Tokyo (JP)

(72) Inventor: KAZUO MORITOMO, Kanagawa (JP)

(21) Appl. No.: 19/458,447

(22) Filed: Jan. 23, 2026

Related U.S. Application Data
(63) Continuation of application No. PCT/JP2024/025196, filed on Jul. 12, 2024.

(30) Foreign Application Priority Data
Jul. 26, 2023 (JP) 2023-121207

(51) Int. Cl. H04W 72/563; H04W 24/10; H04W 72/0457; H04W 88/04

(52) U.S. Cl. CPC H04W 72/563; H04W 24/10; H04W 72/0457; H04W 88/04

(57) ABSTRACT

There is disclosed a relay terminal having a Sidelink relay function to relay communication between a base station and a remote terminal. The relay terminal includes a setting unit configured to set a priority for operation as a Sidelink relay terminal and a transmission unit configured to transmit, to the base station, a message including information relating to the priority. The transmission unit transmits the message each time the priority is updated or periodically.

### CROSS-REFERENCE TO RELATED APPLICATIONS

This application is a Continuation of International Patent Application No. PCT/JP2024/025196, filed Jul. 12, 2024, which claims the benefit of Japanese Patent Application No. 2023-121207, filed Jul. 26, 2023, both of which are hereby incorporated by reference herein in their entirety.

### BACKGROUND

### Field of the Technology

The present disclosure relates to a relay terminal, a base station, a communication method, and a storage medium.

### Description of the Related Art

In recent years, specifications for Long Term Evolution (LTE) and a next-generation communication (New Radio (NR)) under 3rd Generation Partnership Project (3GPP®) have been under development. Among these specifications, a standard specification called Sidelink communication (hereinafter also referred to as “Sidelink”) has been developed. This specification implements direct wireless communication between apparatuses by using an interface called PC5 without using a mobile communication network (core network).

Furthermore, the 3GPP® is advancing the development of specifications for extending the communicable range of Sidelink by using a Sidelink relay function of relaying Sidelink communication via a relay apparatus (relay User Equipment (UE)). For example, as one of the operations of Sidelink communication, there has been specified a procedure for switching the connection path from a direct path where a remote UE directly communicates with a base station to an indirect path where the remote UE indirectly communicates with the base station via a relay UE. According to this procedure, even in a case where the remote UE moves away from the base station making it difficult to communicate with the base station via the direct path, the remote UE is able to continuously communicate with the base station via the relay UE.

US Patent Application Publication No. 2022/0377822 proposes a method by which a remote UE switches the connection path from the direct path to the indirect path.

The relay UE also handles data transfer for the remote UE. Therefore, an increase in the communication traffic of the remote UE places pressure on the communication bandwidth between the relay UE and the base station. Furthermore, if the communication bandwidth becomes congested, the communication speed for services being performed by the relay UE itself, such as video streaming and file transfer, will also be affected. Therefore, it is considered necessary to take into account the communication condition of the relay UE when connecting the remote UE to the relay UE.

### SUMMARY

The present disclosure has been embodied in view of the above-described problems. According to one aspect of the present disclosure, the present disclosure is directed to providing a mechanism for controlling the communication path of a remote UE based on the status of a relay UE.

According to one aspect of the present disclosure, a relay terminal having a Sidelink relay function to relay a communication between a base station and a remote terminal includes a setting unit configured to set a priority for operation as a Sidelink relay terminal, a transmission unit configured to transmit, to the base station, a message including information relating to the priority, wherein the transmission unit transmits the message each time the priority is updated or periodically.

Features of the present disclosure will become apparent from the following description of embodiments with reference to the attached drawings.

### BRIEF DESCRIPTION OF THE DRAWINGS

FIG. 1 is a diagram illustrating a configuration of a communication system according to the present embodiment.

FIG. 2 is a block diagram illustrating an example of a functional configuration of relay User Equipment (UE) according to the present embodiment.

FIG. 3 is a block diagram illustrating an example of a functional configuration of a base station according to the present embodiment.

FIG. 4 is a sequence diagram illustrating processing performed by the communication system according to the present embodiment.

FIG. 5 is a flowchart illustrating processing of the relay UE according to the present embodiment.

FIG. 6 is a flowchart illustrating processing of the base station according to the present embodiment.

FIG. 7 is a flowchart illustrating processing of the base station in a case where the relay UE has a high priority according to the present embodiment.

FIG. 8 is a flowchart illustrating processing of the base station in a case where the relay UE has a high priority according to the present embodiment.

FIG. 9 is a diagram illustrating a format of a SidelinkUEInformationNR message according to the present embodiment.

FIG. 10 is a sequence diagram illustrating processing performed by the communication system according to the present embodiment.

### DESCRIPTION OF THE EMBODIMENTS

Embodiments of the present disclosure will be described below with reference to the accompanying drawings. The following embodiments do not limit the present disclosure in the scope of the appended claims. Although a plurality of features is described in the embodiments, not all of the plurality of features are essential to the present disclosure, and the plurality of features may be arbitrarily combined. In the accompanying drawings, identical or similar components are assigned the same reference numerals, and duplicated descriptions thereof will be omitted.

### First Embodiment

### [System Configuration]

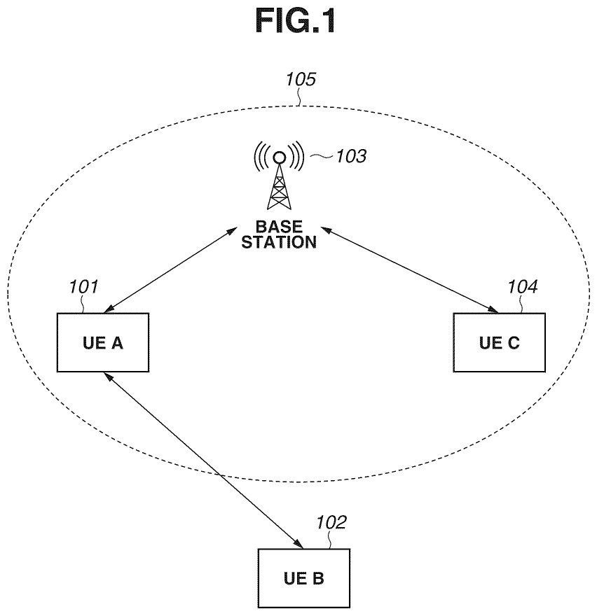

FIG. 1 is a diagram illustrating an example of the configuration of a communication system according to the present embodiment. The communication system includes User Equipment (UE) A 101, UE B 102, UE C 104, and at least one base station 103. The communication system according to the present embodiment is applicable not only to LTE and 5G (NR) but also to communication systems beyond 6G. In the following description, in a case where the UE A 101, the UE B 102, and the UE C 104 are not distinguished, they are collectively referred to as “UE”. The UEs may also be referred to as a terminal. The base stations may be referred to as an enhanced NodeB (eNB) or a gNodeB (gNB).

The UE A 101 has a Sidelink relay function and operates as a relay UE that relays communication between the UE A 101 and the base station 103. The relay UE may also be referred to as a Sidelink relay UE. The relay UE refers to a UE that provides a function supporting a remote UE to connect to a network. The UE B 102 is equipped with a Sidelink communication function and is a remote UE that communicates with the base station 103 via the UE A 101. The remote UE refers to a UE that communicates with a network via the relay UE. The UE C 104 has a Sidelink relay function. The UE C 104 is a candidate relay UE for the UE B 102. The remote UE is an example of a remote terminal. The relay UE is an example of a relay terminal.

The base station 103 generates a base station communication area 105 and communicates with UEs located within the base station communication area 105. The base station communication area 105 is also referred to as a Cell.

Referring to FIG. 1, the UE A 101 and the UE C 104 are located within the base station communication area 105. As the UE B 102 moves, the UE B 102 may possibly be located within the base station communication area 105 as it moves. UEs can perform Sidelink communication with each other regardless of whether a UE is located within the base station communication area 105. In addition, UEs can perform uplink/downlink communication with the base station 103.

### [Functional Configuration of Apparatus]

An example of a functional configuration of a UE will be described below. The configuration of function blocks described below is to be considered as illustrative. Some or all of the function blocks described below may be replaced with other function blocks having similar functions, some of the function blocks may be omitted, and additional function blocks may be added. A single function blocks in the following description may be divided into a plurality of function blocks, and a plurality of function blocks may be integrated into a single function block.

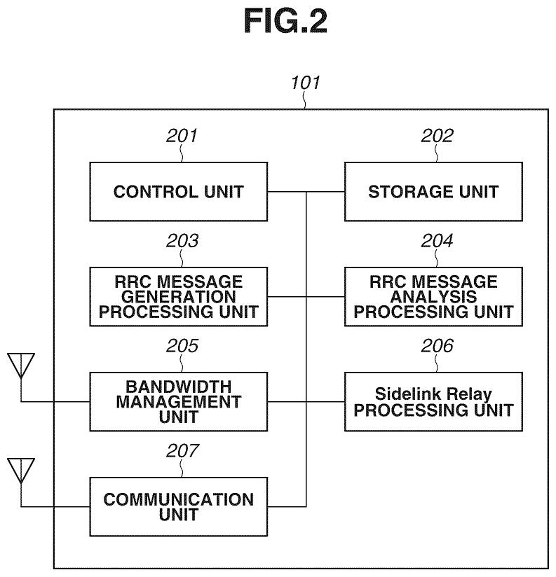

FIG. 2 is a block diagram illustrating an example of a functional configuration of a UE. Here, the communication system according to the present embodiment is described below using the UE A 101.

A control unit 201 controls each component of the UE A 101 in accordance with input signals and programs described below. Instead of the control unit 201 controlling the entire UE A 101, the entire UE A 101 may be controlled by distributing processing among a plurality of hardware components. The control unit 201 also controls a communication establishment unit.

A storage unit 202 stores control programs to be executed by the control unit 201, communication-related information, and parameter values used to determine whether the UE A 101 is operable as a relay UE. Various operations described below are performed when the control unit 201 executes the control programs stored in the storage unit 202.

A Radio Resource Control (RRC) message generation processing unit 203 generates messages used in the RRC, which is a protocol used for control signals between the base station 103 and the UE A 101. The RRC message generation processing unit 203 also generates messages such as DedicatedSIBRequest and SidelinkUEInformationNR described below.

An RRC message analysis processing unit 204 analyzes RRC messages received from the base station 103. For example, the RRC message analysis processing unit 204 analyzes a message and the like including System Information Block (SIB) 12 information described below. “SIB” is an abbreviation for System Information Block. The SIB12 information includes information such as emergency information of a Commercial Mobile Alerting System (CMAS).

A bandwidth management unit 205 manages whether, in communication processing performed by a communication unit 207 described below, sufficient communication bandwidth is secured for services that require communication functions of applications being executed on the terminal. Here, “service” refers to functions provided by the UE A 101 to a user who possesses the UE, such as moving image viewing, web browsing, transmission and reception of Extended Reality/Cross Reality (XR) content data, and file transfer. The bandwidth management unit 205 sets the priority of the UE for operating as a relay UE. The bandwidth management unit 205 is an example of a setting unit.

A Sidelink Relay processing unit 206 connects to a remote UE via the PC5 interface and performs processing for relaying communication between the remote UE and the base station 103.

The communication unit 207 is an interface for communicating with external apparatuses such as the UE and the base station 103, and receives signals from the external apparatuses and transmits signals to them. Examples of interfaces include a PC5 interface (Sidelink communication) conforming to 3GPP® specifications and a Uu interface (uplink/downlink communication). When the communication unit 207 receives communication from external apparatuses such as the UE and the base station 103, it can measure the signal intensity associated with the communication. Examples of the signal intensity include Reference Signal Received Power (RSRP), Reference Signal Received Quality (RSRQ), and Received Signal Strength Indicator (RSSI). The result of the signal intensity measurement performed by the communication unit 207 is notified to the control unit 201. The result of the signal intensity measurement performed by the communication unit 207 may also be reported to the base station 103 in an RRC message. The communication unit 207 also performs processing for transmitting messages generated by the RRC message generation processing unit 203, processing for receiving RRC messages transmitted from the base station 103 and the UE, and processing for transmitting and receiving other necessary wireless signals. The communication unit 207 also transmits, to the base station 103, a message including information about the priority when the UE operates as a relay UE. The communication unit 207 also transmits a message including information related to the priority to the base station 103 each time the priority is updated or on a periodical basis. The communication unit 207 is an example of a transmission unit and a reception unit.

In a case where the communication bandwidth used for communication with the base station 103 exceeds a predetermined threshold value, the communication unit 207 notifies the user that the communication bandwidth exceeds the predetermined threshold value. The communication unit 207 is an example of a notification unit.

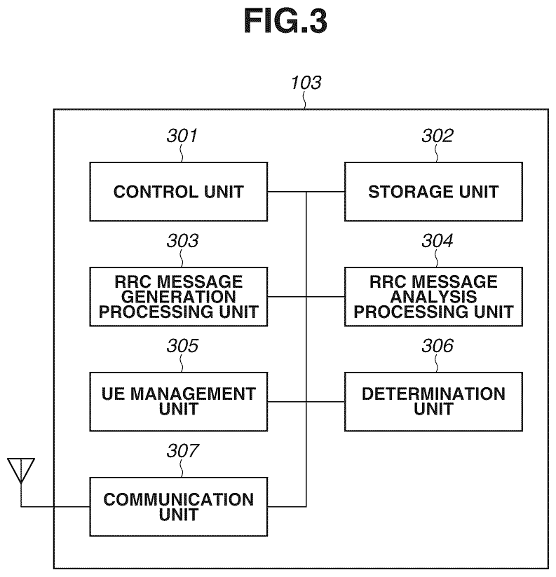

FIG. 3 is a block diagram illustrating an example of a functional configuration of the base station 103.

A control unit 301 controls the operation of the base station 103 based on input signals and programs described below. Instead of the control unit 301 controlling the entire apparatus, the entire apparatus may be controlled by distributing processing among a plurality of hardware components. The control unit 301 also controls a communication establishment unit. The control unit 301 is an example of a control unit.

The control unit 301 controls the communication path of a remote UE based on information related to the priority when the UE operates as a relay UE, and the result of signal intensity measurement notified from the UE.

A storage unit 302 stores control programs to be executed by the control unit 301, and information related to communication as the base station 103. Various operations described below are performed when the control unit 301 executes control programs stored in the storage unit 302.

An RRC message generation processing unit 303 generates messages used in RRC, which is a protocol used for control signals between the base station 103 and the UE.

An RRC message analysis processing unit 304 analyzes RRC messages received from the UE. The RRC message analysis processing unit 304 also processes RRC messages related to DedicatedSIBRequest, SidelinkUEInformationNR, and Measurement Configuration and Reporting, which will be described below.

A UE management unit 305 manages UE information of UEs present within the base station communication area 105, and maintains a management table that stores the UE information for each subordinate UE. The management table also stores identification information for each subordinate UE, and information related to measurement results (e.g., signal intensity) reported from the UE. The management table also manages the operating status of each UE existing within the base station communication area 105, such as whether the UE is operating as a relay UE or as a remote UE. Furthermore, the management table manages information notified via SidelinkUEInformationNR. The UE management unit 305 uses manages, using the management table, information related to the priority for operating as a relay UE, which is transmitted from the relay UE. Moreover, in a case where the base station 103 is communicating with a remote UE via a relay UE, the UE management unit 305 also manages, using the management table, the result of signal intensity measurement reported from the remote UE. The UE management unit 305 is an example of a first management unit and a second management unit.

A determination unit 306 determines, for UEs managed in the management table of the UE management unit 305, whether to perform an indirect connection process via a relay UE or a direction connection process with the base station 103.

The communication unit 307 is an interface for communicating with external apparatuses such as UEs communicating with the base station 103, other base stations, and core network apparatuses. Specifically, examples of such interface include a Uu interface (uplink/downlink communication), an Xn interface (communication between base stations), and an NG interface (communication between a base station and a core network). When the communication unit 307 receives communication from external apparatuses such as UEs and other base stations, it can measure the signal intensity associated with the communication. Examples of the signal intensity may include RSRP, RSRQ, and RSSI. The result of signal intensity measurement performed by the communication unit 307 is notified to the control unit 301. The communication unit 307 also performs processing for transmitting messages generated by the RRC message generation processing unit 303, processing for receiving RRC messages transmitted from UEs, and processing for transmitting and receiving other necessary wireless signals.

The control unit 201 (and likewise the control unit 301) described above includes one or more processors, such as central processing units (CPUs) or micro processing units (MPUs). The control unit 201 controls the entire UE A 101 by executing the control program loaded into the RAM, which serves as the storage unit 202. Each process performed by the control units 201 and 301, as described below with reference to the flowcharts, can also be implemented by using various hardware circuits. Examples of various hardware circuits include an Application Specific Integrated Circuit (ASIC) and a Field Programmable Gate Array (FPGA). Furthermore, the processing of the flowcharts described below can also be implemented by cooperation between hardware circuits and processors such as CPUs or MPUs.

The storage units 202 and 302 may include a main storage unit and an auxiliary storage unit. Examples of the main storage unit include a read only memory (ROM) and a random access memory (RAM). The main storage unit may store or temporarily hold programs and data such as an Operating System (OS), which is basic software executed by the control unit 201, and application software. Examples of the auxiliary storage unit include a hard disk drive (HDD) and a solid state drive (SSD), and may store data related to application software and the like.

For example, a control program stored in a nonvolatile storage area is loaded into the RAM and then executed by a processor included in the control unit 201. In this manner, the control unit 201 and the storage unit 202 may function as a computer.

The storage unit 202 may include a recording medium that stores a predetermined program. A program stored in this recording medium may be installed via a drive apparatus and the like, and the installed predetermined program may be made executable by the control unit 201. Various types of recording media are applicable. Examples of applicable recording media include a Compact Disc Read-Only Memory (CD-ROM), a flexible disk, a magneto-optical disk, and other recording media that record information optically, electrically, or magnetically. The recording medium may be a semiconductor memory that records information electrically, such as a ROM and a flash memory. The recording medium does not include a carrier wave.

The foregoing is one example of a block diagram illustrating an example of a functional configuration of the communication apparatus according to the present embodiment. The present embodiment has been described above centering on the UE A 101; however, the UE B 102 and the UE C 104 may have a similar configuration.

### [Example of Processing]

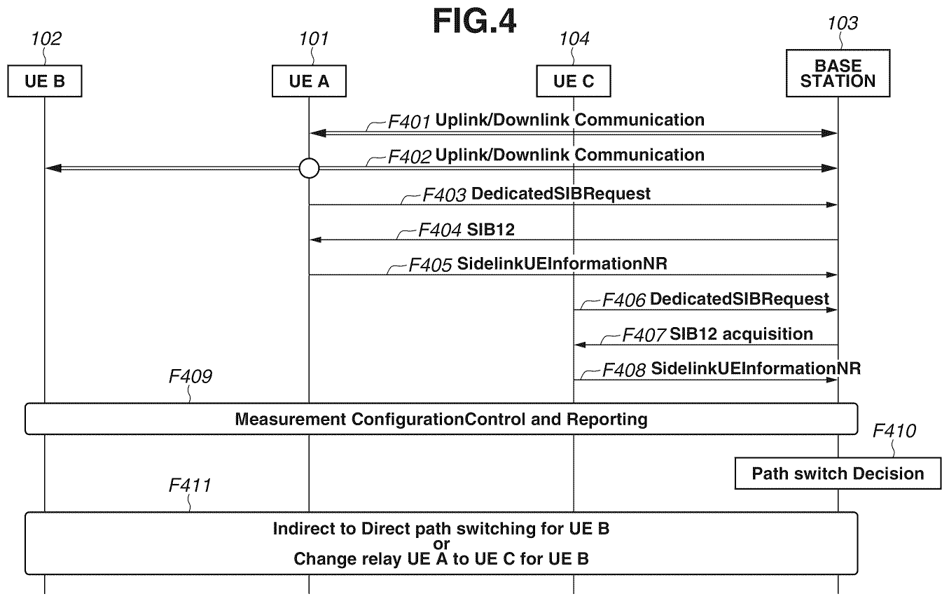

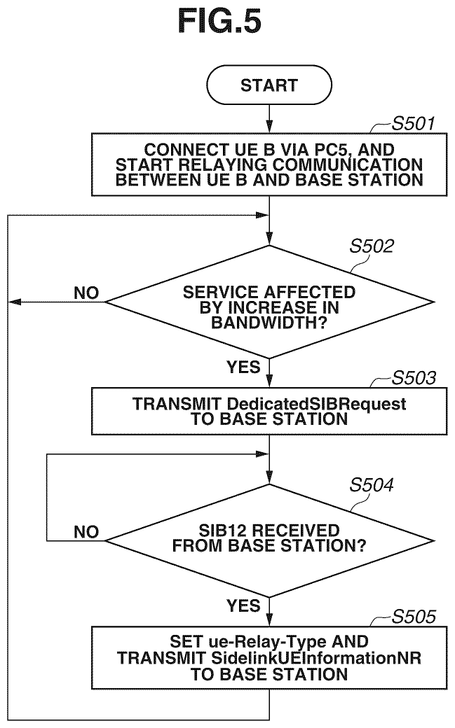

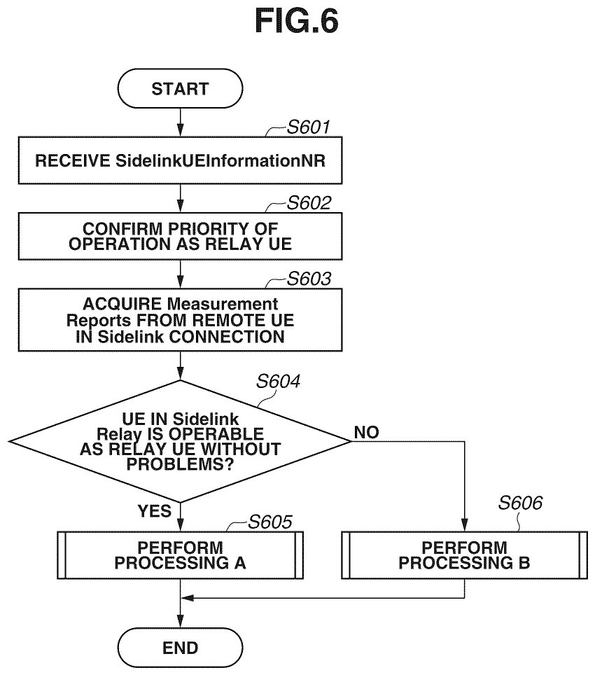

An example of the operation of the present embodiment will be described below with reference to an example of an operating sequence illustrated in FIG. 4, and examples of flowcharts illustrated in FIGS. 5, 6, and 8.

FIG. 4 illustrates processing performed when the base station 103 receives SidelinkUEInformationNR from the UE A 101 and receives a message related to Measurement Configuration and Reporting from the UE B 102. It is assumed that, among the signal intensities measured by the UE B 102 for the UE A 101, the UE C 104, and the base station 103, the signal intensity for the UE A 101 is the strongest.

Even in such a case, depending on the communication status of the UE A 101, the UE B 102 switches from a Sidelink Relay that relays communication via the UE A 101 as a relay UE to direct communication with the base station 103. The details will be described below.

In step F401, the UE A 101 performs uplink/downlink communication with the base station 103 in association with the use of services by the user (e.g., execution of web browsing). In steps F402 and S501, the UE A 101 operates as a relay UE, and performs relay processing of uplink/downlink communication for the UE B 102 operating as a remote UE.

Here, assume that the user of the UE A 101 starts using an additional service (e.g., music streaming) on the UE A 101. As a result, the traffic volume of uplink/downlink communication increases, and, the bandwidth management unit 205 detects a possibility that the normal execution of the service may be hindered due to the increase in communication bandwidth. In this case (YES in step S502), the processing proceeds to step S503. The bandwidth management unit 205 notifies the control unit 201 of possibility that the normal execution of the service may be hindered due to the increase in communication bandwidth. In steps F403 and S503, the control unit 201 generates a DedicatedSIBRequest in the RRC message generation processing unit 203, and transmits the request to the base station 103 via the communication unit 207.

The base station 103 receives the DedicatedSIBRequest from the UE A 101 via the communication unit 307, and analyzes the received request in the RRC message analysis processing unit 304. In step F404, the base station 103 generates a message including SIB12 information in the RRC message generation processing unit 303, and transmits the message to the UE A 101 via the communication unit 307.

In step S504, the communication unit 207 of the UE A 101 receives the SIB12 information (system information related to Sidelink) from the base station 103, and analyzes the information in the RRC message analysis processing unit 204. In a case where the SIB12 information is received from the base station 103 (YES in step S504), the processing proceeds to step S505. In steps F405 and S505, the UE A 101 transmits SidelinkUEInformationNR (a message including information related to priority) including ue-Relay-Type to the base station 103.

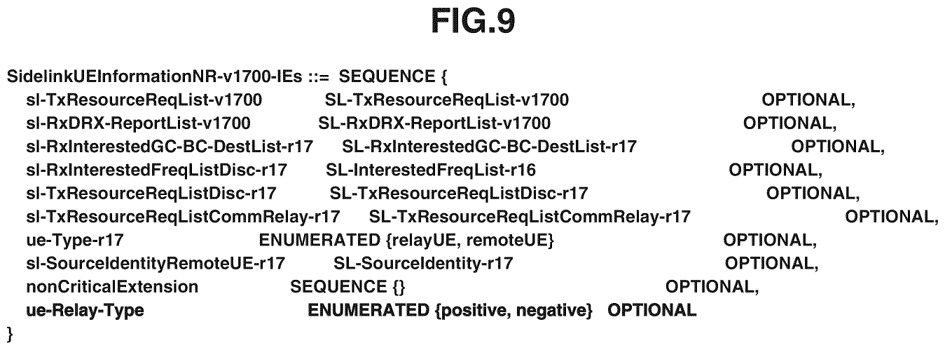

The message format of SidelinkUEInformationNR is illustrated in FIG. 9. According to the present embodiment, an information element called ue-Relay-Type is newly added to SidelinkUEInformationNR. The ue-Relay-Type indicates the priority when operating as a relay UE. The priority represents whether the UE is in a state where it is operable as a relay UE (i.e., a state with high priority for operating as a relay UE) or in a state where operation as a relay UE is to be avoided (i.e., a state with low priority for operating as the relay UE). As an example, in a case where the UE is in a state where it can operate as a relay UE, “Positive” may be set, and in a case where the UE is in a state where operation as a relay UE is to be avoided, “Negative” may be set.

The UE A 101 may determine the priority for operating as a relay UE, based on the communication bandwidth between the UE A 101 and the base station 103 detected by the bandwidth management unit 205. For example, the bandwidth management unit 205 may set the priority to Negative when the communication bandwidth in use between the UE A 101 and the base station 103 is equal to or greater than a predetermined threshold value, or set the priority to Positive when the communication bandwidth in use therebetween is less than the predetermined threshold value. The communication bandwidth in use between the UE A 101 and the base station 103 may be, for example, an average downlink communication speed and/or uplink communication speed during a predetermined communication time.

The UE A 101 may determine the priority for operating as a relay UE, based on the total value of communication bandwidth in use with each remote UE detected by the bandwidth management unit 205. For example, the bandwidth management unit 205 may set “Negative” when the total value of communication bandwidth in use with each remote UE is equal to or greater than a predetermined threshold value, or set “Positive” when the total value is less than the predetermined threshold value. The total value of communication bandwidth in use with each remote UE may be, for example, the sum of values obtained by measuring the average downlink and/or uplink communication speed for each remote UE during a predetermined communication time.

The bandwidth management unit 205 may also set ue-Relay-Type, as the priority for operating as a relay UE, based on the number of remote UEs whose communication is being relayed. For example, if the number of remote UEs connected to the UE A 101 is equal to or greater than a predetermined threshold value, “Negative” may be set. If the number is less than the predetermined threshold value, “Positive” may be set.

The priority for operating as a relay UE may be divided into three or more different levels. For example, ue-Relay-Type may represent three or more different levels such as “High”, “Middle”, and “Low”, instead of two levels such as Positive and Negative.

The priority for operating as a relay UE may be set based on an instruction of the user.

The UE A 101 detects, in the bandwidth management unit 205, that it is in a state where operation as a relay UE is to be avoided. In this case, in steps F405 and S505, the RRC message generation processing unit 203 generates an RRC message in which ue-Relay-Type is set to “Negative”, and the message is transmitted to the base station 103 via the communication unit 307.

In step S601, the base station 103 receives SidelinkUEInformationNR from the UE A 101 via the communication unit 307, and analyzes it in the RRC message analysis processing unit 304. In step S602, the control unit 301 confirms the priority for operating as a relay UE. In this case, the control unit 301 confirms that “Negative” is set in ue-Relay-Type of SidelinkUEInformationNR. The information analyzed by the RRC message analysis processing unit 304 (information indicating that the UE A 101 is “Negative”) is managed in the management information of the UE A 101 in the UE management unit 305.

In step F406 to F408, similar processing is periodically performed in the UE C 104, the results are reflected in the management information of the UE C 104 in the UE management unit 305.

In a case where the UE A 101 and the UE C 104 receive SIB12 from the base station 103, these UEs may omit the transmission of DedicatedSIBRequest in steps F403 and F406. This is because SIB12 is periodically transmitted from the base station 103, and depending on timing, SIB12 can be received without transmitting DedicatedSIBRequest.

The UE B 102 is performing uplink/downlink communication via the UE A 101, which operates as a relay UE, and periodically notifies the base station 103 of communication information around the apparatus using the Measurement Configuration and Reporting mechanism. More specifically, in step F409, the UE B 102 notifies the base station 103 of cells, base stations, and relay UE information that can be detected by the UE B 102, as well as their signal intensities.

The Measurement Configuration and Reporting mechanism will now be described. The base station 103 sets a Measurement Object for the UE, which indicates the target frequency and/or cell identifiers for measuring signal intensities. The UE measures the signal intensities of the radio waves transmitted from one or more base stations existing around the apparatus and the radio wave transmitted from the relay UE, based on Measurement Object set by the base station 103, and notifies (reports) the base station 103 of the measurement results.

Upon reception of Measurement Reports transmitted from the UE B 102 via the communication unit 307, the base station 103 analyzes them in the RRC message analysis processing unit 304. In step S603, information included in the Measurement Reports, such as surrounding apparatus information of UE B 102 and their signal intensity information, which is analyzed by the RRC message analysis processing unit 304, is managed in the management information of UE B 102 in the UE management unit 305.

In steps F410 and S604, the determination unit 306 of the base station 103 examines switching of the connection mode of the UE B 102 based on the management information of the UE A 101, the UE B 102, and the UE C 104 managed in the UE management unit 305.

The following describes how the determination unit 306 examines the switching of the connection mode based on the signal intensities of the base station 103, the UE A 101, and the UE C 104, and the ue-Relay-Type information of the UE A 101 and the UE C 104.

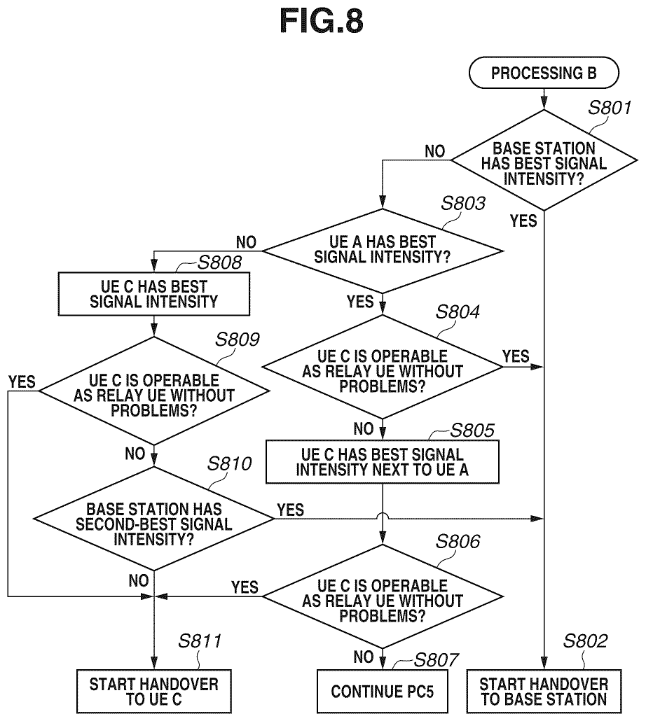

In the present embodiment, in step S606, ue-Relay-Type of the UE A 101 is “Negative”, that is, the UE A 101 is in a state where operation as a relay UE is to be avoided. Processing in this case will be described below with reference to the flowchart in FIG. 8.

In step S801, the determination unit 306 analyzes whether the base station 103 has the highest signal intensity among the apparatuses surrounding the UE B 102.

Here, although this situation differs from that of the present embodiment, reference will be made to the case where the base station 103 has the highest signal intensity among the apparatuses surrounding the UE B 102, which is different from the situation of the present embodiment. In this case, the determination unit 306 determines to switch the communication mode of the UE B 102 from an indirect connection via the UE A 101 as a relay UE to a direct connection with the base station 103. The base station 103 notifies the UE B 102 that the connection mode between the UE B 102 and the base station 103 is switched from the indirect connection via the UE A 101 to the direct connection with the base station 103. Upon reception of the relevant notification, then in step S802, the UE B 102 performs a handover to the base station 103.

Next, the case where the UE A 101 has the highest signal intensity among the apparatuses surrounding the UE B 102 (YES in step S803) will be described. In step S804, the determination unit 306 checks an apparatus having the best signal intensity after the UE A 101. In a case where the apparatus with the next highest signal intensity after the UE A 101 is the base station 103 (YES in step S804), the processing proceeds to steps S802. In step S802 and F411, with respect to the UE B 102, the base station 103 determines that the connection is to be switched from the state of connection via the UE A 101 as a relay UE to a state of direct connection to the base station 103. The base station 103 notifies the UE B 102 of the determination result. Upon reception of the notification, the UE B 102 switches the connection state between the UE B 102 and the base station 103 from the indirect connection via the UE A 101 as a relay UE to the direct connection with the base station 103 in accordance with a predetermined procedure.

In a case where the device with the next highest signal intensity after the UE A 101 is not the base station 103 (NO in step S804), the processing proceeds to step S805. In step S805, the determination unit 306 determines that the UE C 104 is the apparatus with the next highest signal intensity. In step S806, the determination unit 306 determines whether the UE C 104 is operable as a relay UE. In a case where the ue-Relay-Type information in the UE C 104 is set to “Negative” (NO in step S806), the processing proceeds to step S807. In step S807, the determination unit 306 determines that there is no suitable candidate for switching the connection destination, and any switching process is performed.

In the case where the device with the highest signal intensity is neither the base station 103 nor UE A 101, but UE C 104 in step S808, the determination unit 306 compares the ue-Relay-Type information of the UE A 101 and the UE C 104 in step S809. In a case where the ue-Relay-Type information of the UE C 104 is set to “Positive” (YES in step S809), the processing proceeds to step S811. In step S811, the determination unit 306 determines that the connection is to be switched from the state of connection via the UE A 101 as a relay UE to the state of connection via the UE C 104 as a relay UE. In step F411, the base station 103 notifies the UE B 102 of the determination result. Upon reception of the relevant notification, the UE B 102 switches the connection state from the indirect connection via the UE A 101 as a relay UE to the indirect connection via the UE C 104 as a relay UE in accordance with a predetermined procedure.

On the other hand, in a case where the ue-Relay-Type information of the UE C 104 is set to “Negative” (NO in step S809), the processing proceeds to step S810. In step S810, the determination unit 306 checks the apparatus having the next highest signal intensity after the UE A 101. In a case where the apparatus with the next highest signal intensity after the UE A 101 is the base station 103 (YES in step S809), the processing proceeds to step S811. In step S811, the base station 103 determines that the connection is to be switched to a state of direct connection to the base station 103. In step F411, the base station 103 notifies the UE B 102 of the relevant determination result. Upon reception of the notification, then in step S802, the UE B 102 switches the connection state between the UE B 102 and the base station 103 from the indirect connection via the UE A 101 as a relay UE to the direct connection to the base station 103 in accordance with a predetermined procedure.

On the other hand, the case where the apparatus with the next highest signal intensity after the UE C 104 is the UE A 101 will be described. In this case, the ue-Relay-Type information is set to “Negative” for both the UE A 101 and the UE C 104. Therefore, it is determined that the connection is to be switched from the connection state via the UE A 101 as a relay UE to the connection state via the UE C 104 as a relay UE, which has a better signal intensity. In step F411, the base station 103 notifies the UE B 102 of the determination result. Upon reception of the notification, then in step S811, the UE B 102 switches the connection state to the indirect connection via the UE C 104 as a relay UE in accordance with a predetermined procedure.

As described above, in a case where there is a possibility that the continuation of a service being executed by the UE may be hindered, the bandwidth management unit 205 determines that the UE is in a state where operation as a relay UE is to be avoided. The relay UE can immediately notify the base station 103 of the fact.

The base station 103 can solve the above-described concern regarding service continuity by checking the connection state of the remote UE based on information about surrounding apparatuses of the remote UE and information about the relay UE that is in a state where operation as a relay UE is to be avoided.

### Second Embodiment

A second embodiment will be described below centering on an example case where the UE A 101 is operable as a relay UE, and the UE C 104 is in a state where operation as a relay UE is to be avoided.

The system configuration according to the present embodiment is similar to that illustrated in FIG. 1, and the configurations of the apparatuses in the system are also similar to those illustrated in FIGS. 2 and 3.

### (Examples of Processing)

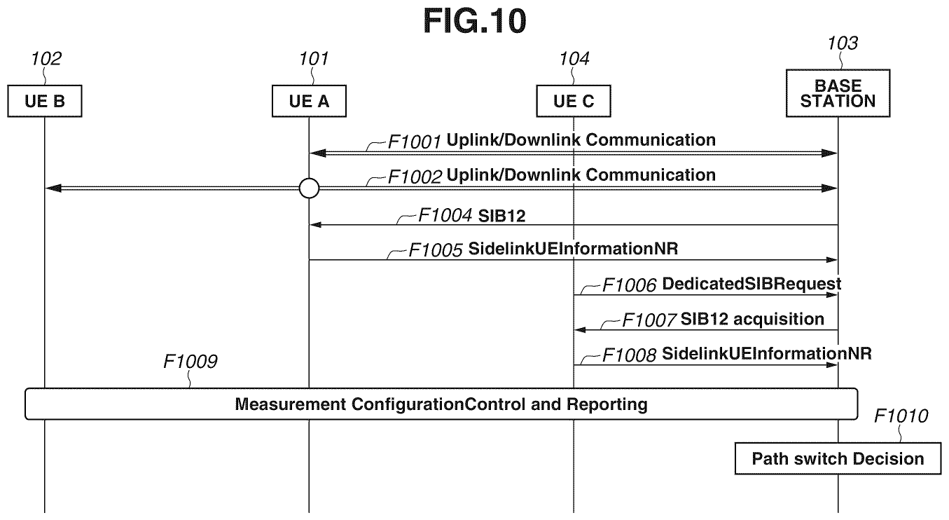

An example of the operation according to the present embodiment will be described below with reference to an example of an operating sequence illustrated in FIG. 10 and examples of flowcharts illustrated in FIGS. 5, 6, and 7.

FIG. 10 illustrates processing performed when the base station 103 according to the present embodiment receives SidelinkUEInformationNR from the UE A 101 and receives a message related to Measurement Configuration and Reporting from the UE B 102. In this case, the signal intensity of the UE C 104 measured by the UE B 102 is better than the signal intensity of the UE A 101 measured by the UE B 102. The signal intensity of the base station 103 measured by the UE B 102 is assumed to be worse than the signal intensities of the UE A 101 and the UE C 104 measured by the UE B 102. According to the present embodiment, even in this case, the UE B 102 continues the Sidelink Relay that relays a communication via the UE A 101 as a relay UE.

Similar to the first embodiment, the UE A 101 is in a connected state with the base station 103 and uplink/downlink communication occurs in association with the execution of applications by the user in step F1001. In steps F1002 and S501, the UE A 101 is operating as a relay UE and performs relay processing of uplink/downlink communication for the UE B 102, which operates as a remote UE.

The UE A 101 communicates with the base station 103 by executing applications on the apparatus itself and relaying communication as a relay UE; however, it is assumed that there is sufficient bandwidth in the communication between the UE A 101 and the base station 103.

In step F1004, the base station 103 periodically generates a message including SIB12 information in the RRC message generation processing unit 303, and transmits the message to the UE A 101 via the communication unit 307.

In step S504, the UE A 101 receives the message including SIB12 information from the base station 103 via the communication unit 207, and analyzes the message in the RRC message analysis processing unit 204. In step F1005, the UE A 101 also generates SidelinkUEInformationNR in the RRC message generation processing unit 203, and transmits it to the base station 103 via the communication unit 207. The message format of SidelinkUEInformationNR is similar to that according to the first embodiment, and redundant descriptions thereof are omitted here.

In the present embodiment, it is assumed that the UE A 101 is operable as a relay UE. Therefore, the RRC message generation processing unit 203 of the UE A 101 generates a message (SidelinkUEInformationNR) in which ue-Relay-Type is set to “Positive”. In steps F1005 and S505, this message is then transmitted to the base station 103 via the communication unit 307.

The processing performed in steps S601 and S602 when the base station 103 receives SidelinkUEInformationNR is similar to that according to the first embodiment, and thus, the description thereof is omitted here.

In this embodiment, it is assumed that the UE C 104 is in a state where operation as a relay UE is to be avoided. In steps F1006 to F1008, processing similar to the method described in the first embodiment is performed, and information indicating that the UE C 104 is in a state where operation as a relay UE is to be avoided is reflected in the management information of the UE C 104 in the UE management unit 305.

In step F1009, the UE B 102 is performing uplink/downlink communication via the UE A 101 as a relay UE, and periodically notifies the base station 103 of communication information around the UE B 102 using the Measurement Configuration and Reporting mechanism. Specifically the information includes the signal intensity between the UE B 102 and the base station 103 and the signal intensity between the UE B 102 and the relay UE.

The processing performed when the base station 103 receives a message related to Measurement Configuration and Reporting in steps F1010 and S603 is similar to that according to the first embodiment, and the description thereof is omitted here.

The following describes how the base station 103 switches the connection mode of the UE B 102 based on the signal intensities of the base station 103, the UE A 101, and the UE C 104, and the ue-Relay-Type information of the UE A 101 and the UE C 104 in step S604.

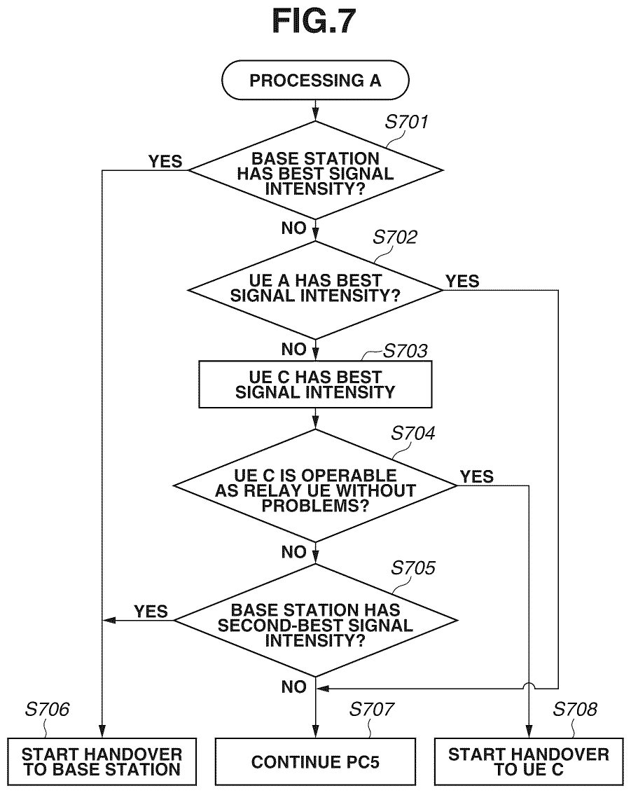

In the present embodiment, as described above, ue-Relay-Type of the UE A 101 is “Positive”, that is, the UE A 101 is in a state where it can operate as a relay UE (step S605). The processing procedure in this case will be described below with reference to the flowchart in FIG. 7.

As described above, ue-Relay-Type of the UE A 101 is set to “Positive”, that is, the UE A 101 is in a state where there is no problem in operating as a relay UE.

Like the first embodiment, in step S701, the determination unit 306 analyzes whether the base station 103 has the highest signal intensity with the UE B 102. Here, although this situation differs from that assumed in the present embodiment, reference will be made to the case where the signal intensity of the base station 103 measured by the UE B 102 is better than the signal intensities of other UEs measured by the UE B 102. In this case, the determination unit 306 determines that UE B 102 is to change the communication mode from an indirect connection via the UE A 101 as a relay UE to a direct connection with the base station 103. In step S706, the base station 103 notifies the UE B 102 of the switching of the connection mode from the indirect connection via the UE A 101 to the direct connection to the base station 103.

Next, consider the case where the highest signal intensity with the UE B 102 is not from the base station 103 but from the UE A101 in step S702. Although this situation also differs from that assumed in the present embodiment, reference will be made to it. In this case, in step S707, the determination unit 306 determines that the UE B 102 is to maintain the connection state using the UE A 101 as a relay UE, and no switching processing is particularly performed.

Finally, consider the case where the highest signal intensity with the UE B 102 is neither from the base station 103 nor from the UE A 101, but from the UE C 104 in step S703. In step S704, the determination unit 306 compares the ue-Relay-Type information of the UE A 101 and the UE C 104. In the present embodiment, it is assumed that the ue-Relay-Type information of the UE A 101 and the UE C 104 is set to “Negative”. In this case, in step S705, the signal intensity of the base station 103 is checked again. In the present embodiment, since the base station 103 has the worst signal intensity, it is recognized that the next highest signal after the UE C 104 is from the UE A 101. Although the signal intensity of the UE A 101 is inferior to that of the UE C 104, because the ue-Relay-Type information of the UE A 101 is set to “Positive”, no switching process is performed.

Reference will also be made to the case where the next highest signal after the UE C 104 is from the base station 103. In this case, in step S706, the base station 103 determines that the UE B 102 is to switch from the connection state using the UE A 101 as a relay UE to the state of direct connection to the base station 103.

Further, although this situation differs from that assumed in the present embodiment, reference will also be made to the case where the ue-Relay-Type information of the UE C 104 is set to “Positive”. In this case, in step S708, the base station 103 notifies the UE B 102 of the switching of the connection destination to the UE C 104 having a better signal intensity.

As described above, even in a case where relay UE candidates other than the apparatus itself exist and the signal intensities of such candidates are better than that of the apparatus, in a case where the relay UE candidate is in a state where operation as a relay UE is to be avoided, it becomes possible to suppress switching of the relay UE.

### Other Embodiments

In the first embodiment, the operability as a relay UE has been described based on the factor of increased communication bandwidth caused by activation of a service on the relay UE. However, the present disclosure is not limited to this factor regarding the operability as a relay UE.

For example, the operability as a relay UE may be intentionally set by the user of the relay UE. In a case where the communication bandwidth of the relay terminal exceeds a predetermined threshold value, the user may be notified of the fact and, at this time, the user of the relay UE may set a priority.

Furthermore, the priority for operating as a relay UE may be set based on the apparatus characteristics of the relay UE. For example, in a case of an apparatus such as a smart phone on which various services are activated, a setting that operation as a relay UE is to be avoided is desirable.

Meanwhile, in the case of a communication relay apparatus or a communication auxiliary apparatus installed on a roadway or the like to support a communication apparatus located outside the coverage area of the base station 103, active use as a relay UE is desirable. Therefore, in this case, a setting indicating that there is no hindrance to operation as a relay UE is desirable.

In the above-described example, a remote UE that has been using a smart phone as a relay UE can smoothly transition to another relay UE by detecting a communication relay apparatus, a communication auxiliary apparatus, or the like installed on a road or the like.

In the present embodiment as well, in a case where a terminal operating as a relay UE is likely to encounter a hindrance to continuing operation as a relay UE, it is possible to prompt a change of the connection destination to another relay UE or to the base station via the base station.

According to one aspect of the present disclosure, it is possible to provide a mechanism that enables control of the communication path of a remote UE based on the state of a relay UE.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present disclosure is not limited to the above-described embodiments, and various changes and modifications can be made without departing from the spirit and scope of the present disclosure. Accordingly, the following claims are appended to publicly indicate the scope of the present disclosure.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A relay terminal having a Sidelink relay function to relay a communication between a base station and a remote terminal, the relay terminal comprising:
a reception unit configured to receive a signal from the base station; and
a transmission unit configured to transmit, to the base station, a message including information relating to a priority for operation as a Sidelink relay terminal,
wherein the transmission unit transmits the message each time the priority is updated or periodically.

2. The relay terminal according to claim 1, further comprising a setting unit configured to set the priority by comparing a communication bandwidth used for communication with the base station with a predetermined threshold value.

3. The relay terminal according to claim 1, further comprising a setting unit configured to set the priority based on an instruction from a user.

4. The relay terminal according to claim 1, further comprising a notification unit configured to, in a case where a communication bandwidth used for communication with the base station exceeds a predetermined threshold value, notify a user that the communication bandwidth has exceeded the predetermined threshold value.

5. The relay terminal according to claim 1, further comprising a setting unit configured to set the priority based on apparatus characteristics of the relay terminal.

6. The relay terminal according to claim 1, further comprising a setting unit configured to set the priority based on a number of remote terminals for which communication is being relayed.

7. The relay terminal according to claim 1,
wherein the reception unit receives system information relating to Sidelink from the base station, and
wherein, in a case where the system information is received, the transmission unit transmits, to the base station, a message including information relating to the priority.

8. A base station configured to communicate with a remote terminal via a relay terminal having a Sidelink relay function, the base station comprising:
a first management unit configured to manage information relating to a priority for operation as a Sidelink relay terminal, which is transmitted from the relay terminal;
a second management unit configured to, in a case where the base station is communicating with the remote terminal via the relay terminal, manage a measurement result of a signal intensity reported from the remote terminal; and
a control unit configured to control a communication path of the remote terminal based on the information relating to the priority and the measurement result.

9. A communication method executed by a relay terminal having a Sidelink relay function to relay communication between a base station and a remote terminal, the communication method comprising:
receiving a signal from the base station; and
transmitting, to the base station, a message including information relating to a priority for operation as a Sidelink relay terminal,
wherein the message is transmitted each time the priority is updated or periodically.

10. A communication method executed by a base station configured to communicate with a remote terminal via a relay terminal having a Sidelink relay function, the communication method comprising:
managing information relating to a priority for operation as a Sidelink relay terminal, which is transmitted from the relay terminal;
managing, in a case where the base station is communicating with the remote terminal via the relay terminal, a measurement result of a signal intensity reported from the remote terminal; and
controlling a communication path of the remote terminal based on the information relating to the priority and the measurement result.

11. A non-transitory computer-readable storage medium storing a program which, when executed by a relay terminal having a Sidelink relay function to relay communication between a base station and a remote terminal, causes the relay terminal to:
receive a signal from the base station; and
transmit, to the base station, a message including information relating to a priority for operation as a Sidelink relay terminal,
wherein the message is transmitted each time the priority is updated or periodically.

12. A non-transitory computer-readable storage medium storing a program which, when executed by a base station configured to communicate with a remote terminal via a relay terminal having a Sidelink relay function, causes the base station to:
manage information relating to a priority for operation as a Sidelink relay terminal, which is transmitted from the relay terminal;
manage, in a case where the base station is communicating with the remote terminal via the relay terminal, a measurement result of a signal intensity reported from the remote terminal; and
control a communication path of the remote terminal based on the information relating to the priority and the measurement result.
